(19) United States
(12) Patent Application Publication
(10) Pub. No.: US 2024/0341357 A1
(43) Pub. Date: Oct. 17, 2024

(54) Electronic Smoking Device with a Battery Housing

(71) Applicant: JT International SA, Geneva (CH)

(72) Inventor: Daniel Lickefeld, Riol (DE)

(73) Assignee: JT International SA, Geneva (CH)

(21) Appl. No.: 18/682,711

(22) PCT Filed: Aug. 11, 2022
(86) PCT No.: PCT/EP2022/072599

§ 371 Date: Feb. 9, 2024

(30) Foreign Application Priority Data
Aug. 13, 2021 (EP) 21191236.5

(51) Int. Cl. A24F 40/42; A24F 40/10; A24F 40/51; A24F 40/70; H01M 4/04; H01M 4/583; H01M 50/121

(52) U.S. Cl. CPC A24F 40/42; A24F 40/10; A24F 40/51; A24F 40/70; H01M 4/0457; H01M 4/583; H01M 50/121; H01M 2220/30

(57) ABSTRACT

The present invention relates to an electronic smoking device comprising at least one battery assembly for supplying the electronic smoking device with power, a measuring assembly for measuring device-related parameters, a control unit to evaluate at least one measurement parameter and an aerosol generating assembly which generates aerosol from an aerosol generating product inside at least one cartridge, wherein the battery assembly comprises a galvanic element, characterized in that the galvanic element is at least partially integrated in a housing, wherein the housing surrounds at least the measuring assembly. the control unit, the cartridge and the aerosol generating assembly of the electronic smoking device. The invention relates also to a housing for an electronic smoking device and a method for manufacturing this housing.

The present invention relates to an electronic smoking device comprising a galvanic element which is at least partially integrated in a housing of the electronic smoking device. The invention also relates to a housing for above mentioned electronic smoking device and a method for manufacturing the housing.

The common e-vapor devices are known as handy and very small in size portable devices. So far, the battery seems to be the largest component in the most types of the e-vapor devices. This means that only a very small amount of consumables can be stored in the device. The consumer has to keep changing new cartridges with consumables because they typically last for only several puffs. To solve this problem, it is possible to provide cartridges with a larger volume. However, the size of the whole e-vapor device enlarges with the cartridge.

It is therefore the objective of the invention to improve the space utilization inside the e-vapor devices and keeping its shape still handy and small in size. Furthermore, the objective of the invention is also to provide a housing for such e-vapor devices and a method for manufacturing the housing.

The above-mentioned requirement is met by the object of claim 1. Preferred embodiments are objects of the dependent claims.

An electronic smoking device comprising at least one battery assembly for supplying the electronic smoking device with power, a measuring assembly for measuring device-related parameters, a control unit to evaluate at least one measurement parameter and an aerosol generating assembly which generates aerosol from an aerosol generating product inside at least one cartridge. The battery assembly comprises a galvanic element and is at least partially integrated in a housing. The housing surrounds at least the measuring assembly, the control unit, the cartridge and the aerosol generating assembly of the electronic smoking device.

The term partially integrated in the housing means especially that the galvanic element and/or sub elements of the galvanic elements are inside the housing and/or inside a wall that forms the housing. Preferably the housing surrounds the galvanic elements or sub elements of the galvanic element in a circumferential direction. Preferably other elements can be fixed to the housing.

The term partially is understood that parts of the galvanic element, for example in the length direction might extend outside the housing and/or outside a wall forming the housing.

Preferably the battery assembly comprises two electrodes, preferably the positive (anode) and negative (cathode) electrodes, and an electrolyte. The electrolyte is preferably non-aqueous and preferably comprises at least lithium salts such as Lithium hexafluorophosphate, ethylene carbonate, diethyl carbonate or others. Furthermore, the electrodes preferably comprise at least 2-D structures of graphene, graphite, amorphous silicon, tin dioxide, Lithium titanium oxide, lithium iron phosphate, or other materials. It is also possible that the battery assembly and in particular the galvanic element comprises a Lithium ion battery and/or another type of rechargeable batteries. Depending on the electronic smoking devices technical features and its handy shape, it is conceivable to use battery types with reduced weight.

It is conceivable that the electronic smoking device comprises two or more battery assemblies. This allows a longer service life of the electronic smoking device. Especially for the modern electronic smoking devices with high technological features a higher capacity of the battery assembly is indispensable.

In the common devices, the battery assembly is one of the largest components. The battery assembly integrated in the housing preferably significantly enlarges the available installation space in the electronic smoking device. Due to this, it is possible to use the available enlarged installation space for further components of the electronic smoking device, especially a storage for cartridges with the aerosol generating products.

In another aspect, the aerosol generating assembly is utilizable for solid or liquid components of the aerosol generating product, wherein each of the components comprise different properties in use. The aerosol generating assembly is preferably adapted to the selected components and their properties. It is conceivable that the aerosol generating assembly comprises a heater, an aerosolizer or other mechanical components for generating aerosol or vapor. A user has to select between the electronic smoking devices for products with solid and liquid components because only one type of the aerosol generating products have been usually used in the electronical smoking devices so far. Thus, preferably the electronic smoking device comprises more than one aerosol generating assemblies, preferably two aerosol generating assemblies.

Preferably measuring assembly of the electronic smoking device measures device-related parameters like battery charge level, filling level of the aerosol generating product in the cartridge, degree of contamination in the mechanical parts or other significant parameters. In particular the measuring assembly enables complete operation monitoring of the electronic smoking device. In case of several battery assemblies arranged in the electronic smoking article, it is conceivable that the measuring assembly measures several battery-related parameters, preferably battery charge levels. Preferably the measuring assembly transmits the device-related and/or the battery-related parameters to the control unit.

Preferably the control unit of the electronic smoking device evaluates the device-related and/or the battery-related parameters. It is conceivable that the control unit combines the battery-related parameters of several battery assemblies to a common battery charge level. This may affect a simplified overview of the several battery charge levels of the used battery assemblies.

According to another embodiment, the battery assembly and/or the housing comprises at least one graphene layer.

It has been found that graphene improves electrode materials of the battery assemblies and/or the housing of the electronic smoking device with the integrated galvanic element. In consequence of unique properties of graphene, such as large surface to mass ratio, good chemical stability and very high electrical conductivity, it is possible to expand the energy storage of the battery assemblies.

Preferably the graphene layer comprised in the battery assembly and/or the housing of the electronic smoking device is a 2-D sheet material. The 2-D sheet material preferably comprises carbon atoms.

It is possible that the battery assembly and/or the housing of the electronic smoking device comprises two graphene layers, preferably single atomic layers of carbon. It has been found that the lithium ions located between the graphene layers act as an electrode material of the battery assembly and/or the housing. Preferably such electrode material comprises a specific capacity between 540 and 960 mAhg⁻¹, more preferred 744 mAhg⁻¹.

The housing is preferably coated or laminated by graphene at least in part. It is possible that an inner surface of the housing encases the installation space inside the electronic smoking device. Preferably the graphene or at least one graphene layer is applicable on the inner surface of the housing during the manufacturing process of the battery assembly.

Preferably the housing comprises a single-layer graphene or few-layer graphene. Preferably the few-layer graphene or the single-layer graphene extends along the circumferential and longitudinal directions of the electronic smoking device inside its housing. Also preferably the single-layer or few-layer graphene is adhesively attached to the inner surface of the housing.

According to another embodiment, the housing is a functional part of the galvanic element.

The term functional part of the battery is to be understood as being a part that contributes to the function of the battery and especially to the electrical function of the battery. Preferably the housing forms a part of at least one electrode of the battery and/or the housing of the device is also a housing of the battery. In a preferred embodiment that battery is not removable from the housing. Preferably the functional element fullfills a double function for example serving as a housing (and for example being relevant for protection functions) and furthermore contributing to the function and especially the electrical function of the battery.

Preferably the housing of the electronic smoking device is circumferentially coated with graphene. In this way, the coated surface works as a part of the electrode material. It is conceivable to use the coated housing or the surface with graphene as a cathode or an anode material of the battery assembly. Thus, the housing is preferably a not exchangeable part of the galvanic element or the battery assembly. It is also conceivable that the housing further comprises at least one insulating layer.

It has been found that the disadvantages like high cost, toxicity or low operating voltage, regarding to the common cathode or anode materials comprised in the Li-ion batteries can be overcome by the graphene layers comprised in the battery assembly and/or the housing. Due to the chemical properties of the graphene, they are exploitable to the properties of the whole battery assembly.

Preferably the available installation space in the electronic smoking device is increased by the housing being a functional part of the galvanic element or the battery assembly. In particular, the battery assembly is arranged in the housing the electronic smoking device at least in part.

Preferably the housing functional laminate of the battery assembly and/or the galvanic element. According to another embodiment, the housing consists of one basic material, preferably being a polymer or aluminum. Also preferably, the basic material or the housing comprises polycarbonate.

The term basic material refers to the material the housing substantially consists of. Preferably the portion or percentage of the basic material in the housing and/or the material of the housing is larger than 80 wt. %, preferably larger than 85 wt. %, preferably larger than 90 wt. %, preferably larger than 95 wt. %.

The basic material of the housing preferably comprises graphene. It has been found that the basic material is miscible with graphene, wherein graphene is preferably present as flakes. The graphene or graphene flakes and polymer are preferably dispersible in a dispersant, preferably 1,3-dioxolane-based dispersion. Preferably the dispersion comprises a twofold function and is able to dissolve the polymer. The dissolved polymer is preferably a final composite for admixing the graphene or graphene flakes. It is also conceivable to admix the graphene with polycarbonate.

In another embodiment, the housing consists of titan at least in part. Due to the thermal and electrical properties of titan, it has been found that housing consisting of titan at least in part comprises a low weight and corrosion resistance. These properties are advantageous for handy electronic smoking devices.

In another embodiment, the housing comprises a layered structure. Preferably the basic material is a carrier for the further layers or laminates. Also preferably the basic material supports at least one insulating layer or laminate, at least one graphene layer and further necessary layers for the construction of the battery assembly. Due to this, it is conceivable that at least one laminate of the housing works as an electrical resistance of the battery assembly.

According to another embodiment, the housing consists of a polycarbonate-based graphene material, wherein preferably the graphene is dispersed and dissolved in the basic material and/or polycarbonate-based graphene material. Preferably in this embodiment the basic material of the housing is a polycarbonate based graphene material in which preferably the graphene is dispersed and dissolved. In another preferred embodiment the polycarbonate based graphene material is dissolved in the polymer material of the housing and/or the aluminium material of the housing. It has been found that graphene improves the mechanical and thermal properties and electrical conductivity of the polymer or polycarbonate.

Preferably the housing of the device is an element that houses other parts of the device, for example surrounds them, especially in order to protect them. Preferably the housing is an element surrounding other elements. In one preferred embodiment the housing can be a one piece element. However it is also possible that the housing comprises two or more pieces fixed together.

Preferably the dissolved polymer and/or polycarbonate and graphene are components of the polycarbonate-based graphene material. It has been found that the polycarbonate and/or polymer is particularly dissolvable in a liquid dispersion, preferably 1,3-dioxolane-based dispersion. Due to this, it is conceivable that the polycarbonate-based graphene material further comprises at least components of the liquid dispersion, preferably 1,3-dioxolane-based dispersion.

In another embodiment, the few-layer graphene is preferably present as a film. The few-layer graphene film is preferably adhesively attached to the battery assembly, preferably as a part of the housing. Due to the fact that the few-layer graphene film comprises carbon atoms that are arranged in a hexagonal honeycomb lattice, it has been found that the few-layer graphene films are producible via chemical vapour deposition. Preferably the few-layer graphene film comprises multiple graphene domains which are growing to merge into a continuous film.

It is also conceivable to intercalate further substances into a few-layer graphene structure. Due to this, preferably the few-layer graphene is developable into the polycarbonate-based graphene material, also preferably other hybrid materials or heterostructures.

According to another embodiment, the housing comprises graphene in a ratio of more than 0.1 wt. %, preferably more than 0.7 wt. %, also preferably more than 1.5 wt. %, more preferred more than 3 wt. % and less than 5 wt. %, preferably less than 4 wt. %, more preferred less than 3 wt. % with respect to the housing weight.

Enhancing the basic material of the housing with graphene is advantageous in view of fascilatation of heat dissipation, increasing the capacity of the battery assembly and faster charging. Preferably the battery assembly with the housing comprising graphene as a part of the battery assembly comprises a capacity in a range of 1,2 Ah and 5 Ah. The capacity of the battery assembly preferably depends on the ratio of the comprised graphene in the housing and at least on type of battery used in the battery assembly.

2 According to another embodiment, the housing comprises a wall thickness of at least 0.5 mm, preferably at least 3 mm, also preferably at least 5 mm, more preferred at least 7 mm, most preferred at least 10 mm. The wall thickness of the housing is further depend on type of battery used in the battery assembly and basic material of the housing.

According to another embodiment, the housing comprises a touchable outer surface which comprises at least one insulating layer. The touchable outer surface of the housing preferably comprises electrical and electronical components for operating the electronic smoking device. It is conceivable that the outer surface further comprises buttons, LEDs, displays or touchscreens.

The term touchable refers to all elements of the device that can be touched from the outside and/or in an assembled state of the device. Preferably the touchable elements are also visible from the outside in an assembled state.

The objective is also reached by a housing for an electronic smoking device. The electronic smoking device comprises at least one battery assembly for supplying the electronic smoking device with power, a measuring assembly for measuring device-related parameters, a control unit to evaluate at least one measurement parameter and an aerosol generating assembly which generates aerosol from an aerosol generating product inside at least one cartridge. The battery assembly comprises a galvanic element. According to the invention, the galvanic element is at least partially integrated in the housing. The housing surrounds at least the measuring assembly, the control unit, the cartridge and the aerosol generating assembly of the electronic smoking device.

Preferably the housing comprises at least one electrode and is a functional part of the battery assembly. Also preferably the battery assembly is connected to the measuring assembly and the control unit of the electronic smoking device. Preferably the measuring assembly comprises means for measuring device-related parameters, in particular battery-related parameters. Also preferably the control unit comprises means for processing the device-related parameters.

Preferably the battery assembly is rechargeable and comprises means for quick charging.

The objective is also reached by a method for manufacturing a housing for an electronic smoking device,

comprising following steps
providing the ingredients comprising polycarbonate, 1,3-dioxolane-based dispersion, single layer and/or few layer graphene;
dissolving the polycarbonate in the 1,3-dioxolane-based dispersion creating thereby a polycarbonate dispersion;
adding single layer and/or few layer graphene to the polymer dispersion thereby creating a polycarbonate-based graphene dispersion;
drying the polycarbonate-based graphene dispersion thereby creating a polycarbonate-based graphene material;
forming the housing for the electronic smoking device from the polycarbonate-based graphene material.

Preferably the steps of the method described above are carried out one after another in the following order: providing step, dissolving step, adding the graphene step, drying step and forming step.

Preferably the solvent ingredients of the polycarbonate dispersion such as polycarbonate or polymer and graphene are provided as powder with a particle size of at least 30 μm. Alternatively, the solvent ingredients are provided as pellets, flakes or solved in a aqueous carrier.

The liquid ingredients of the polycarbonate dispersion preferably comprise N-methyl-2-pyrrolidone. It is conceivable to create a graphene dispersion before dissolving the polycarbonate in the 1,3-dioxolan-based dispersion. Preferably, the ratio of polycarbonate in the 1,3 dioxolan-based dispersion is between 30:40 and 34:46, more preferably 32:43. It has been found that the ration of polycarbonate in the 1,3 dioxolan-based dispersion of 32:43 gives the best result in terms of homogeneous dispersion characteristic. It has been shown that 500 mg of graphite disperse in 50 ml of N-methyl-2-pyrrollidone and exfoliate in a sonic bath, preferably in VWR Ultrasonic Cleaner USC-THD, for at least 6 hours. Due to this, it is conceivable that graphite and a solvent, preferably N-methyl-2-pyrrollidone, are provided in a ratio of 10:1 relating to the total weight of the graphene dispersion.

It is conceivable that the graphene dispersion is ultra-centrifuged. Preferably the ultra-centrifugation is performed by 15° C. for at least 30 min. It is conceivable that the graphene dispersion comprises a residual liquid which preferably comprises N-methyl-2-pyrrollide. Preferably the residual liquid of the graphene dispersion is collectable in a further manufacturing step of the housing. It is also possible to boil the graphene dispersion at 78° C.

Preferably the method for manufacturing the housing comprises an evaporation process of the solvent, preferably N-methyl-2-pyrrollidone. It has been shown that a dispersed graphene remains after the solvent is evaporated at least to an amount of 15%, more preferred 10%, regarding to the total weight of the graphene dispersion. The obtained results highlight the optimal synergy between polycarbonate/1,3 dioxolane-based material these condition

Also preferably, the method for manufacturing the housing comprises a rinsing or washing step, wherein the dispersed graphene is washed or rinsed by a polar aprotic solvent, preferably acetone, y-Butyrolactone, dimethyl carbonate, ethylene carbonate or other aprotic solvents. It is conceivable that the rinsing or washing step is repeatable for at least 3 times, preferably 5 times.

According to another embodiment, the method for manufacturing the housing comprises stirring the polycarbonate dispersion for at least 3 h, preferably to achieve a stirred slurry material. Preferably the polycarbonate dispersion comprises the single layer and few layer graphene which is admixable to the solvent. Due to proper reaction of the stirred slurry material, the stirred slurry material comprises a viscosity of at least 510 [mPa*s]. Also preferably, the stirred slurry material comprises a density of at least 1,2 [g/cm2]. It has been found that stirring the polycarbonate dispersion for more than 3 h hours increases the material viscosity. This leads to improper material behavior for the next manufacturing steps like drying etc. Preferably the polycarbonate dispersion is stirred for maximum 3.5 h.

According to another embodiment, the drying step is achieved by a vacuum oven at least 80° C. It is also conceivable that the drying step is further achieved by pouring water. A drying temperature is crucial since the dried material need to reach a certain condition to become not to brittle. Preferably the drying temperature of the polycarbonate dispersion, preferably the stirred slurry material, is in range of 80° C. and 90° C.

According to another embodiment, the polycarbonate-based graphene dispersion is drying for at least 12 h. It has been shown that the polycarbonate-based graphene dispersion is dryable until the dispersion is coagulated or precipitated. In other embodiments, the drying step may last up to 12,5 hours. This fact depends especially on chosen solvent for the polycarbonate-based graphene. It is also conceivable that the polycarbonate-based graphene dispersion is drying for less than 12 hours.

According to another embodiment, mixing the polycarbonate-based graphene dispersion by means of ultra-sonication for at least 2 h.

According to another embodiment, mixing the polycarbonate-based graphene dispersion maintaining a temperature in range of 25° C. to 40° C. thereby dispersing all ingredients homogeneously.

The steps in the method for manufacturing the housing and especially polycarbonate-based graphene material could comprise further manufacturing steps.

The forming step of the housing is preferably achieved by providing the polycarbonate-based dispersion on rolls likewise as a wire. Preferably the housing is formable by fused deposition molding or fused filament fabrication.

It is conceivable that the forming step comprises heating the polycarbonate-based graphene material. Preferably the polycarbonate-based graphene material is formable at least due to the thermoplastic energy supply. Additionally or alternatively, the forming step comprises cooling the formed polycarbonate-based graphene material, preferably in a mould. Preferably the heated polycarbonate-based graphene material is attachable in the mould.

However, after all mixing steps, it is conceivable to dry the polycarbonate-based graphene dispersion in the drying step of the method. Preferably the polycarbonate-based graphene dispersion is dried to a formable or kneadable shape thereby creating a polycarbonate-based graphene material. In the last step of the method, preferably a housing is formed by using means for molding to a predefined shape. In another embodiments, the method preferably comprises further steps of post-processing the housing.

It is conceivable that a milling step is necessary to mill recesses in the housing. It is also conceivable that a further step of laying wires or electrical traces is necessary to create at least one electrical contact. Preferably the method comprises a coating attaching step, wherein an electrolyte material is attached to the preformed polycarbonate-based material. Also preferably the method may comprise a further attaching step, wherein an anode material is attached to the electrolyte material. However, it is also conceivable that the method further comprises a wiring step with wires, wherein wires and/or electrical traces are attached to the anode material and the polycarbonate-based material, being preferably a cathode.

Further advantages, objectives and features of the present invention will be described, by way of example only, in the following description with reference to the appended figures. In the figures, like components in different embodiments can exhibit the same reference symbols.

The figures show:

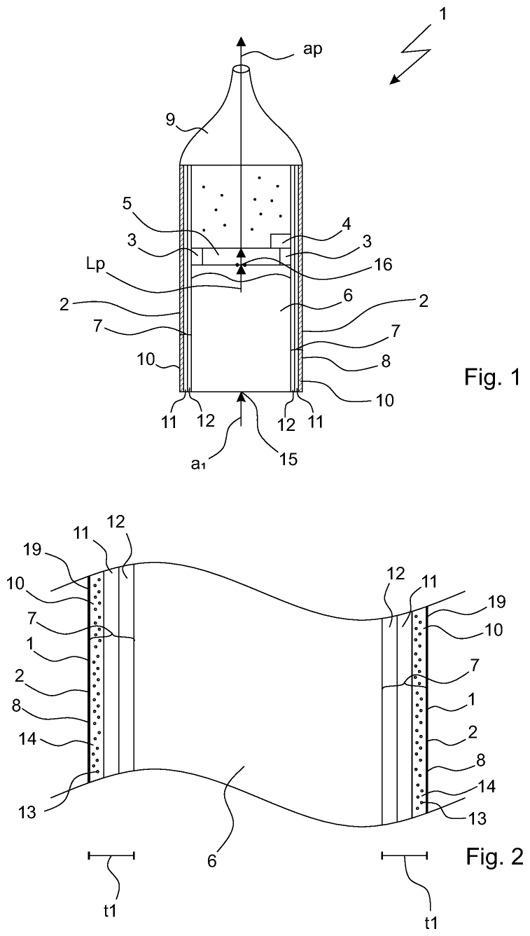

FIG. 1 schematic cross-sectional view of an electronic smoking device comprising a housing as a functional part of a battery assembly;

FIG. 2 enlarged schematic cross-sectional view of a housing with dispersed graphene in its basic material;

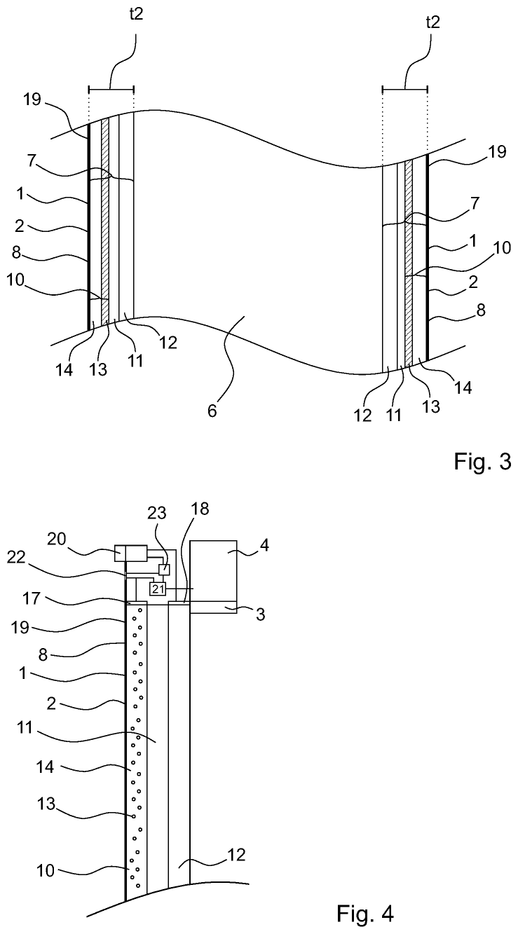

FIG. 3 enlarged schematic cross-sectional view of a housing with graphene as an attached layer to a basic material;

FIG. 4 enlarged schematic cross-sectional view of a housing being a functional part of a battery assembly connected to further electronic and electrical components of the electronic smoking device;

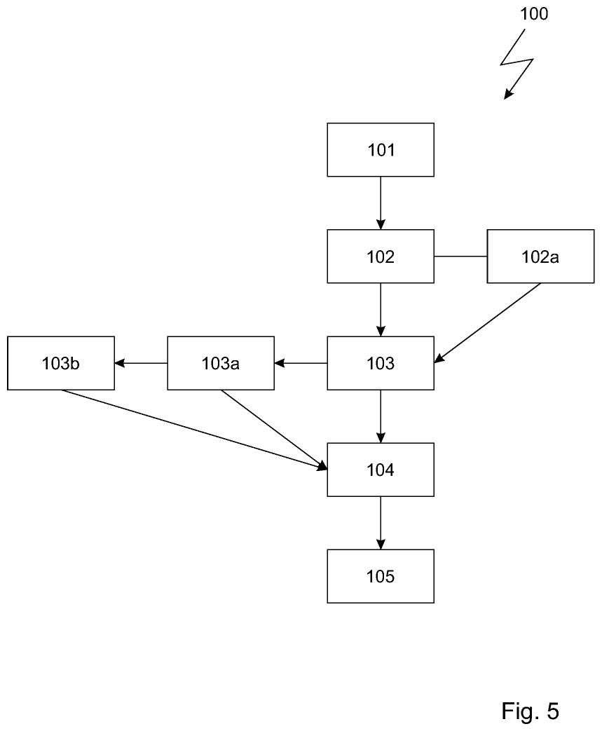

FIG. 5 a flow chart of a method for manufacturing a housing with graphene.

FIG. 1 shows a schematic cross-sectional view of an electronic smoking device 1 comprising a housing 8 as a functional part of a battery assembly 2. In particular the electronic smoking device 1 in FIG. 1 is an illustrative example of a device which generates aerosol off a liquid consumable. However, it is also conceivable to use the housing 8 being a functional part of the battery assembly 2 in other types of electronic smoking devices. Due to this, the following description is not to be understood as limiting.

Preferably the electronic smoking device 1 comprises at least one cartridge 6 for storage of the consumable. The cartridge 6 is preferably exchangeable or refillable. Due to this, preferably the electronic smoking device 1 comprises means for fixing the cartridge 6 and/or for refilling the cartridge 6 (not shown).

The shown electronic smoking device 1 comprises a mouthpiece 9 preferably attached to the housing 8. It is conceivable but not necessary that the mouthpiece is an exchangeable part of the electronic smoking device 1.

In the shown embodiment of the electronic smoking device 1, air a1 is flowing through an air inlet 15 of the cartridge 6 or the housing 8 thereby ensuring pressure equalisation in the cartridge 6 during a user draws on the mouthpiece 9. Preferably the electronic smoking device 1 further comprises a measuring assembly 3, control unit 4 and an aerosol generating assembly 5. It is conceivable that the liquid flows along a liquid flow path lp through an opening 16 in the aerosol generating assembly 5. Preferably the aerosol generating assembly 5 further comprises means for generating aerosol (not shown). After the aerosol is generated, it flows preferably along an aerosol path through the mouthpiece 9 to the user's mouth.

The housing 8 of the electronic smoking device 1 comprises preferably a layered structure with a layer as a cathode 10, an electrolyte 11 and at least an anode 12. Further layers as components of the housing 8 are also conceivable. Due to the layered structure, the housing 8 is preferably a functional part of the battery assembly 2 of the electronic smoking device 1. In the shown embodiment, all layers of the housing 8 represent a galvanic element 7 of the battery assembly 2. It is also conceivable that only a part of the housing 8 acts as a functional part of the battery assembly 2.

FIG. 2 shows an enlarged schematic cross-sectional view of a housing 8 with dispersed graphene 13 in its basic material 14. In the shown figure the housing 8 comprises at least four layers being the anode 12, the electrolyte 11 and the cathode 10. In particular the cathode 10, the electrolyte 11 and the anode 12 layers are parts of the galvanic element 7 of the battery assembly 2.

Preferably the cathode 10 layer comprises a basic material 14 and dispersed graphene 13 particles. It is conceivable that the graphene 13 particles comprise a size of at least 30 μm or less. In other embodiments the graphene 13 particles comprise a larger size, preferably a size of 100 μm. However, the graphene 13 is preferably continuously distributed in the basic material 14 thereby creating a homogeneous hybrid material.

The housing 8 preferably further comprises an insulating layer 19. Preferably the insulating layer 19 is the outermost layer of the housing 8 and thereby forms an outer surface of the housing 8 and/or the electronic smoking device 1. Preferably the cathode 10 being the basic material 14 with dispersed graphene 13 is adhesively attached to the insulting layer 19. Furthermore, the cathode 10 is separated from the anode 12 via an electrolyte 11. Due to this, preferably the cathode 10 layer is attached to the electrolyte 11 layer and the electrolyte layer 11 is attached to the anode 12 layer. It is conceivable that further layers, preferably adhesive layers, PET substrate layers, hydrogel layers or other layers, are comprised in the layered structure of the housing 8 (not shown). In another embodiments, the housing 8 comprises copper layers and/or electrical tracks (not shown).

Preferably the housing 8 being at least a part of the battery assembly 2 comprises a wall thickness t1 of at least 5 mm. It is also conceivable that the wall thickness t1 varies depending on the type of the used basic material 14 and a number of the layers in the housing 8. However, the housing 8 is considered as an operative part of the battery assembly 2 of the device 1.

FIG. 3 shows an enlarged schematic cross-sectional view of a housing 8 with graphene 13 as an attached layer to a basic material 14. In particular, FIG. 3 shows another embodiment of the housing 8 comprising graphene 13 and being a part of the battery assembly 2.

Preferably the housing 8 comprises at least five layers being the insulting layer 19, the basic material 14 layer, the graphene 13 layer, the electrolyte 11 layer and the anode 12 layer. In particular, the basic material 14 layer and the graphene 13 layer together form the cathode 10 layer. Preferably the graphene 13 layer is adhesively attached to the basic material 14 20) layer.

The housing 8 shown in FIG. 3 comprises a wall thickness t2 which preferably comprises 6 mm or less. In some embodiments the wall thickness t2 is larger than 7 mm. In particular the wall thickness t2 is preferably larger than the wall thickness t1, due to the fact that the graphene 13 is a separate layer.

FIG. 4 shows an enlarged schematic cross-sectional view of a housing 8 being a functional part of a battery assembly 2 connected to further electronic and/or electrical components of the electronic smoking device 1. In particular FIG. 4 shows an embodiment of the housing 8 which is similar to the housing shown in FIG. 2.

The housing 8 of the electronic smoking device 1 preferably further comprises electrical and/or electronical components for operation of the device 1, preferably such as LED 22, an trigger 20, a connector 21 and at least a resistor 23. The shown embodiment is not to be understood as limiting. It is conceivable that the electronic smoking device 1 comprises other or additional electrical and/or electronic components.

As already shown in FIG. 2, the cathode 10 layer preferably comprises the basic material 14 layer with dispersed graphene 13. Preferably the cathode 10 layer further comprises an electrical contact being a negative contact 17 of the battery assembly 2. Also preferably the anode 12 layer comprises a second electrical contact being a positive contact 18 of the battery assembly 2.

Preferably the negative contact 17 of the battery assembly 2 is connected to the LED 22. Also preferably the LED 22 is further connected to the resistor 23. It is conceivable that the resistor 23 comprises a suitable value of resistance for this application. However, the resistor 23 is preferably connected to the control unit 4 of the electronic smoking device 1.

Preferably the positive contact 18 of the battery assembly is connected to the trigger 20. It is conceivable that the trigger 20 is a button or switch. In another embodiment the trigger 20 is a touch screen. Preferably the trigger 20 is further connected to the resistor 23. Also preferably the resistor 23 and the LED 22 is connected to a connector 21. Preferably the connector 21 is a functional part of the control unit 4. Also preferably the control unit 4 is connected to the measuring assembly 3.

In the shown embodiment the electrical connections are shown as black lines. It is conceivable that the connections are electrical traces or wires.

FIG. 5 shows a flow chart of a method 100 for manufacturing a housing 8 with graphene 13. Preferably the method 100 begins with a first step which is providing 101 the ingredients of the polycarbonate-based graphene material. Preferably the polycarbonate-based material comprises at least the basic material 14 and graphene 13. Also preferably the basic material 14 is polycarbonate or polymer. The second step of the method 100 is preferably dissolving 102 the basic material 14 in a solvent, preferably the 1,3-dioxolane-based dispersion. During the dissolving 102 step a polycarbonate dispersion is preferably created. Additionally, it is possible that a stirring 102a step is necessary for manufacturing the housing 8. Preferably the stirring step 102a comprises stirring polycarbonate dispersion for at least 3 h. after dissolving 102 or stirring 102a step, preferably an adding step 103 is necessary. The adding step 103 preferably comprises adding graphene 13 to the polycarbonate dispersion. It is conceivable that graphene 13 is a single layer and/or few layer graphene. During the adding step 103 a polycarbonate-based graphene dispersion is preferably created. Additionally, it is conceivable to mix 103a the polycarbonate-based graphene dispersion is mixable by means of ultra-sonication for at least 2 h. It is conceivable to maintain a temperature in range of 25° C. and 40° C. during the mixing 103b of polycarbonate-based graphene dispersion.

The applicant reserves his right to claim all features disclosed in the application document as being an essential feature of the invention, as long as they are new, individually or in combination, in view of the prior art. Furthermore, it is noted that in the figures features are described, which can be advantageous individually. Someone skilled in the art will directly recognize that a specific feature being disclosed in a figure can be advantageous also without the adoption of further features from this figure. Furthermore, someone skilled in the art will recognize that advantages can evolve from a combination of diverse features being disclosed in one or various figures.

### LIST OF REFERENCE SYMBOLS

1 electronic smoking device
2 battery assembly
3 measuring assembly
4 control unit
5 aerosol generating assembly
6 cartridge
7 galvanic element
8 housing
9 mouthpiece
10 cathode
11 electrolyte
12 anode
13 graphene
14 basic material
15 air inlet
16 opening
17 negative contact
18 positive contact
19 insulating layer
20 trigger/button
21 connector/aerosol generating assembly
22 LED
23 resistor
100 method for manufacturing the housing
101 providing the ingredients
102 dissolving the polycarbonate
102a stirring the polycarbonate
103 adding graphene to the polycarbonate
103a mixing the polycarbonate-based graphene dispersion for at least 2 hours
103b mixing the polycarbonate-based graphene dispersion maintaining a temperature
104 drying the polycarbonate-based graphene dispersion
105 forming the housing
a1 air
ap aerosol path
lp liquid path
t1 wall thickness of the housing
t2 wall thickness of the housing

1. An electronic smoking device comprising at least one battery assembly for supplying the electronic smoking device with power, a measuring assembly for measuring device-related parameters, a control unit to evaluate at least one measurement parameter and an aerosol generating assembly which generates aerosol from an aerosol generating product inside at least one cartridge, wherein the battery assembly comprises a galvanic element, wherein
the galvanic element is at least partially integrated in a housing, and wherein the housing surrounds at least the measuring assembly, the control unit, the cartridge and the aerosol generating assembly of the electronic smoking device.

2. The electronic smoking device according to claim 1, wherein
the battery assembly and/or the housing comprises at least one graphene layer.

3. The electronic smoking device according to claim 1, wherein
the housing is a functional part of the galvanic element.

4. The electronic smoking device according to claim 1, wherein
the housing is formed of one basic material, the basic material being a polymer or an aluminum.

5. The electronic smoking device according to claim 4, wherein
the housing comprises a polycarbonate-based graphene material, and wherein the graphene is dispersed and dissolved in the basic material.

6. The electronic smoking device according to claim 4, wherein
the housing comprises graphene in a ratio of more than 0.1 wt. % and less than 5 wt. %, with respect to weight of the housing.

7. The electronic smoking device according to claim 1, wherein
the housing comprises a wall thickness of at least 0.5 mm.

8. The electronic smoking device according to claim 1, wherein
the housing comprises a touchable outer surface which comprises at least one insulating layer.

9. A housing for an electronic smoking device, wherein the electronic smoking device comprises at least one battery assembly for supplying the electronic smoking device with power, a measuring assembly for measuring device-related parameters, a control unit to evaluate at least one measurement parameter and an aerosol generating assembly which generates aerosol from an aerosol generating product inside at least one cartridge, wherein the battery assembly comprises a galvanic element, wherein
the galvanic element is at least partially integrated in the housing, wherein the housing surrounds at least the measuring assembly, the control unit, the cartridge and the aerosol generating assembly of the electronic smoking device.

10. A method for manufacturing a housing for an electronic smoking device, the method comprising steps of:
providing ingredients comprising a polycarbonate, a 1,3-dioxolane-based dispersion, and one or more layers of graphene;
dissolving the polycarbonate in the 1,3-dioxolane-based dispersion thereby creating a polycarbonate dispersion;
adding the one or more layers of graphene to the polymer dispersion thereby creating a polycarbonate-based graphene dispersion;
drying the polycarbonate-based graphene dispersion thereby creating a polycarbonate-based graphene material;
forming the housing for the electronic smoking device from the polycarbonate-based graphene material.

11. The method for manufacturing according to claim 10, further comprising:
stirring the polycarbonate dispersion for at least 3 h.

12. The method for manufacturing according to claim 10, wherein
the drying step is achieved by a vacuum oven at at least 80° C.

13. The method for manufacturing according to claim 10, wherein
the is drying step occurs for at least 12 h.

14. The method for manufacturing according to claim 10, further comprising:
mixing the polycarbonate-based graphene dispersion using ultrasonication for at least 2 h.

15. The method for manufacturing according to claim 14, wherein
during the mixing step, the method further comprises maintaining a temperature of the polycarbonate-based graphene dispersion in a range between 25° C. and 40° C. thereby dispersing all ingredients homogeneously.
